(19) United States
(12) Patent Application Publication
(10) Pub. No.: US 2006/0251859 A1
(43) Pub. Date: Nov. 9, 2006

(54) Friction drag-reducing surface

(76) Inventor: Brian R. D'Urso, Clinton, TN (US)

Correspondence Address: UT-Battelle, LLC;Office of Intellectual Property, One Bethal Valley Road, 4500N, MS-6258, Oak Ridge, TN, 37831, US

(21) Appl. No.: 11/122,582

(22) Filed: May 5, 2005

(51) Int. Cl. G11B 5/64

(52) U.S. Cl. 428/141; 428/156

(57) ABSTRACT

An article includes a body having at least one viscous drag-reducing surface defining a multiplicity of macro-scale depressions separated and enframed by ridges, at least a portion of the surface being phobic to a preselected liquid so that gas bubbles may be trapped in the macro-scale depressions in order to reduce viscous drag between the article and the liquid.

The United States Government has rights in this invention pursuant to contract no. DE-AC05-00OR22725 between the United States Department of Energy and UT-Battelle, LLC.

### CROSS-REFERENCE TO RELATED APPLICATIONS

Specifically referenced and incorporated herein by reference are: U.S. patent application Ser. No. 10/900,248 filed on Jul. 27, 2004 by Brian R. D'Urso and John T. Simpson entitled “Composite, Ordered Material Having Sharp Surface Features”; and U.S. patent application Ser. No. 10/900,249 filed on Jul. 27, 2004 by Brian R. D'Urso and John T. Simpson entitled “Composite, Nano-Structured, Super-Hydrophobic Material”.

### FIELD OF THE INVENTION

The present invention relates to materials having surfaces that are designed to reduce friction drag at a solid-liquid interface, and more particularly to such materials having appropriately phobic microscale characteristics in combination with macroscale depressions on a surface thereof.

### BACKGROUND OF THE INVENTION

A water-repellant but non-super-hydrophobic surface (by the generally accepted contact angle >150 degrees definition) was shown to decrease drag in a pipe (K. Watanabe et al, “Drag reduction of Newtonian fluid in a circular pipe with a highly water-repellant wall”, J. Fluid Mechanics, vol. 381, p. 225, 1999).

There are few currently available materials which efficiently provide significant viscous drag reduction over large areas for applications such as watercraft and ducts. Specifically referenced and incorporated herein by reference is U.S. Patent Application Publication No. US 2005/0061221 A1, Ser. No. 10/493,054, PCT filed on Oct. 29, 2002 by Mariusz Paszkowski entitled “Superhydrophobic Coating”.

Some super-hydrophobic materials may decrease drag on a microscopic length scale, which could be useful for micro-fluidics applications, but none are expected to give significant drag reduction on a macroscopic scale, as would be needed for drag reduction for watercraft (T. Min et al, “Effects of hydrophobic surface on skin-friction drag”, Physics of Fluids, vol. 16, no. 7, 2004).

Decreased drag in watercraft will enable faster, more fuel-efficient, and/or decreased signature watercraft. Such benefits will be particularly useful for defense and commercial applications. Even a reduction of a few percent in drag can result in significant speed increase and/or fuel savings for sundry watercraft and water ducts. The present invention is directed toward such needs.

### OBJECTS OF THE INVENTION

Accordingly, objects of the present invention include provision of friction drag reducing surface features suitable for watercraft applications, ducts, and other applications where friction between a solid material and a liquid material need to be reduced. Further and other objects of the present invention will become apparent from the description contained herein.

### SUMMARY OF THE INVENTION

In accordance with one aspect of the present invention, the foregoing and other objects are achieved by an article that includes a body having at least one viscous drag-reducing surface defining a multiplicity of macro-scale depressions separated and enframed by ridges, at least a portion of the surface being phobic to a preselected liquid so that gas bubbles may be trapped in the macro-scale depressions in order to reduce viscous drag between the article and the liquid.

### BRIEF DESCRIPTION OF THE DRAWINGS

FIG. 1 is a photomicrograph of a microscale, disordered hydrophobic base material in accordance with some embodiments of the present invention.

FIG. 2 is a photomicrograph of a microscale, ordered hydrophobic base material in accordance with some embodiments of the present invention.

FIG. 3 is a schematic, oblique, isometric, cutaway view of a material having super-hydrophobic macroscale depressions in a surface thereof in accordance with some passive embodiments of the present invention.

FIG. 4 is a schematic top view of the material shown in FIG. 3.

FIG. 5 is a schematic lateral view through section A-A of the material shown in FIG. 4.

FIG. 6 is a schematic lateral view through section B-B of the material shown in FIG. 4.

FIG. 7 is a schematic, oblique, isometric, cutaway view of a material having super-hydrophobic depressions in a surface thereof in accordance with some active embodiments of the present invention.

FIG. 8 is a schematic top view of the material shown in FIG. 7.

FIG. 9 is a schematic lateral view through section A-A of the material shown in FIG. 8.

FIG. 10 is a schematic lateral view through section B-B of the material shown in FIG. 8.

For a better understanding of the present invention, together with other and further objects, advantages and capabilities thereof, reference is made to the following disclosure and appended claims in connection with the above-described drawings.

### DETAILED DESCRIPTION OF THE INVENTION

The invention preferably uses a material having a multi-scale surface feature to trap a gas layer at the surface of the material to significantly reduce the drag on a macroscopic scale. A multiscale surface feature includes at least one microscale surface feature and at least one macroscale surface feature. The macroscale feature is a depression on the surface for trapping a discrete gas bubble, and the microscale feature renders the surface hydrophobic for holding the gas bubble in the depression. An appropriately phobic surface (phobic to a particular liquid material in which the surface is immersed) which is not necessarily characterized by a microscale surface feature is also contemplated to fall within the scope of the present invention.

Embodiments of the present invention involve a multiscale material of a highly hydrophobic base material with surface depressions enframed (i.e., surrounded) by sharp ridges for drag reduction. The surface depressions trap air or other gas, forming, in effect, a layer of the gas over much of the surface of the material which decreases viscous or friction drag on the surface moving through a liquid (typically water), or on the liquid traveling across the surface (as in a pipe). The gas is held in the depressions by the combination of the hydrophobic material and surface depressions enframed by sharp ridges. The sharp ridges which enframe the depressions prevent the gas layer from being forced off by pressure gradients in the liquid. In passive embodiments of the material, more gas may be picked up from the surrounding liquid. In active embodiments of the material, the depressions are filled with gas and pressurized from behind the surface through holes leading into the depressions.

Microscale Feature

A microscale surface feature, as used herein, has general dimensions as defined in Table 1.

TABLE 1

| | Dimension | | | | | |
|---|---|---|---|---|---|---|
| | Length | | Width | | Depth | |
| Range | Min. | Max. | Min. | Max. | Min. | Max. |
| Operable | 1 nm | 1 μm | 1 nm | 1 μm | 1 nm | 10 μm |
| Preferable | 10 nm | 500 nm | 10 nm | 500 nm | 10 nm | 10 μm |
| More | 20 nm | 100 nm | 20 nm | 100 nm | 20 nm | 500 μm |
| Preferable | | | | | | |

| | | | |
|---|---|---|---|
| Most | 50 nm | 50 nm | 250 nm |
| Preferable | | | |

The base material in which there are depressions has hydrophobic or preferably super-hydrophobic microscale features in applications where water is the liquid in which the surface is immersed. A super-hydrophobic material may comprise a hydrophobic material or hydrophobic coated material with micrometer-scale or nanometer-scale features.

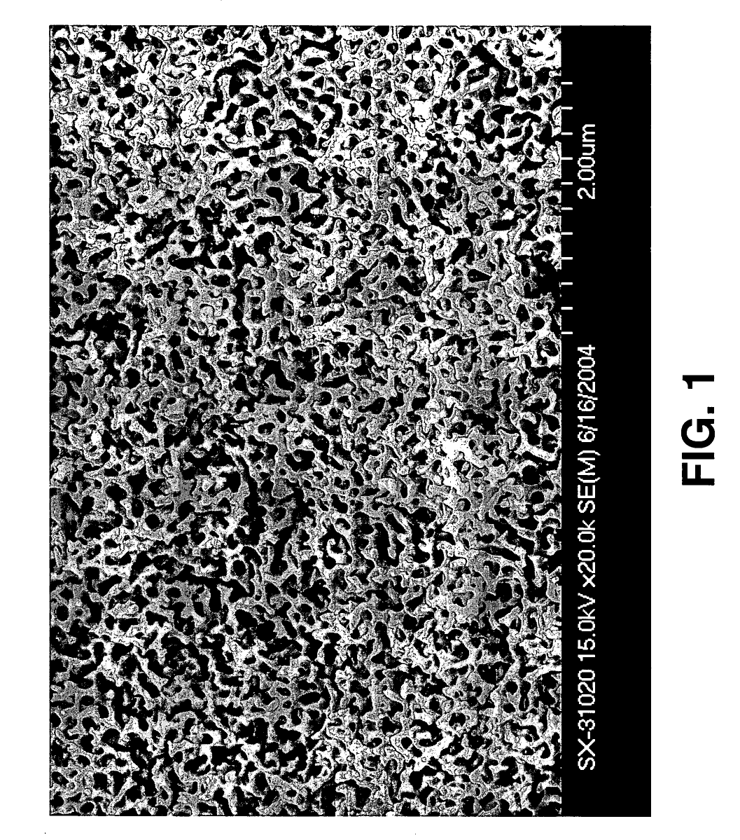

Referring to FIG. 1, particularly easily adapted super-hydrophobic materials include disordered super-hydrophobic materials produced by etching a composite produced by spinodal decomposition of a parent material. The materials are described in detail in U.S. patent application Ser. No. 10/900,249 filed on Jul. 27, 2004 by Brian R. D'Urso and John T. Simpson entitled “Composite, Nano-Structured, Super-Hydrophobic Material”, the entire disclosure of which incorporated herein by reference.

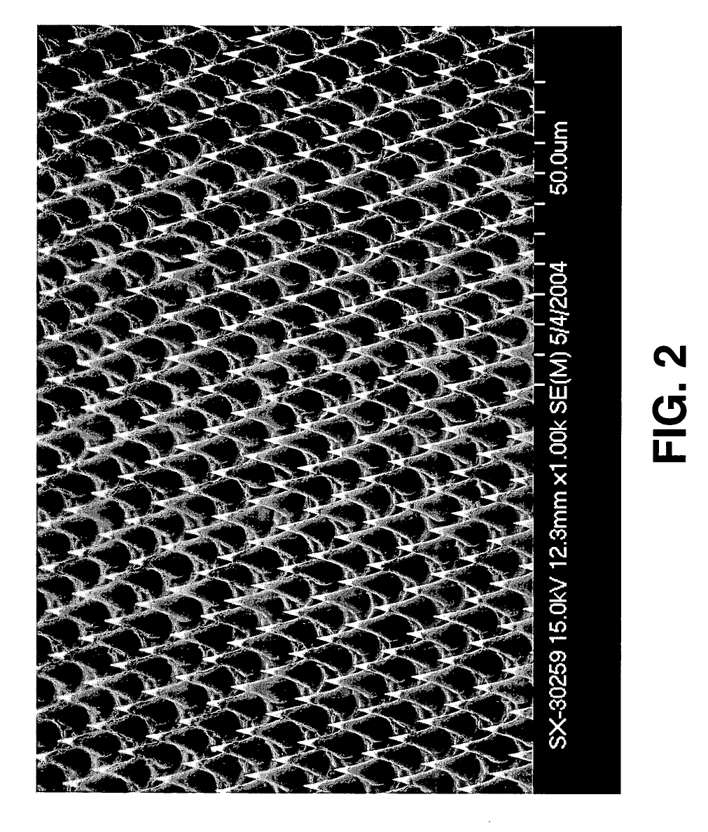

Referring to FIG. 2, another easily adapted material is described in detail in U.S. patent application Ser. No. 10/900,248 filed on Jul. 27, 2004 by Brian R. D'Urso and John T. Simpson entitled “Composite, Ordered Material Having Sharp Surface Features”, the entire disclosure of which incorporated herein by reference.

A microscale surface can include nanoscale features and can be multiscale, as described in the above referenced and incorporated patent applications.

The skilled artisan will recognize that, in applications where a liquid other than water is the liquid in which the surface is immersed, a material that has appropriate phobic characteristics is used. All such applications are considered to fall within the scope of the present invention.

Macroscale Feature

A macroscale feature, as used herein, has general dimensions as defined in Table 2.

TABLE 2

| | Dimension | | | | | |
|---|---|---|---|---|---|---|
| | Length | | Width | | Depth | |
| Range | Min. | Max. | Min. | Max. | Min. | Max. |
| Operable | 1 μm | 100 cm | 1 μm | 10 cm | 1 μm | 10 cm |
| Preferable | 10 μm | 10 cm | 10 μm | 1 cm | 10 μm | 1 cm |
| More | 100 μm | 1 cm | 100 μm | 5 mm | 100 μm | 5 mm |
| Preferable | | | | | | |

| | | | |
|---|---|---|---|
| Most | 10 mm | 1 mm | 1 mm |
| Preferable | | | |

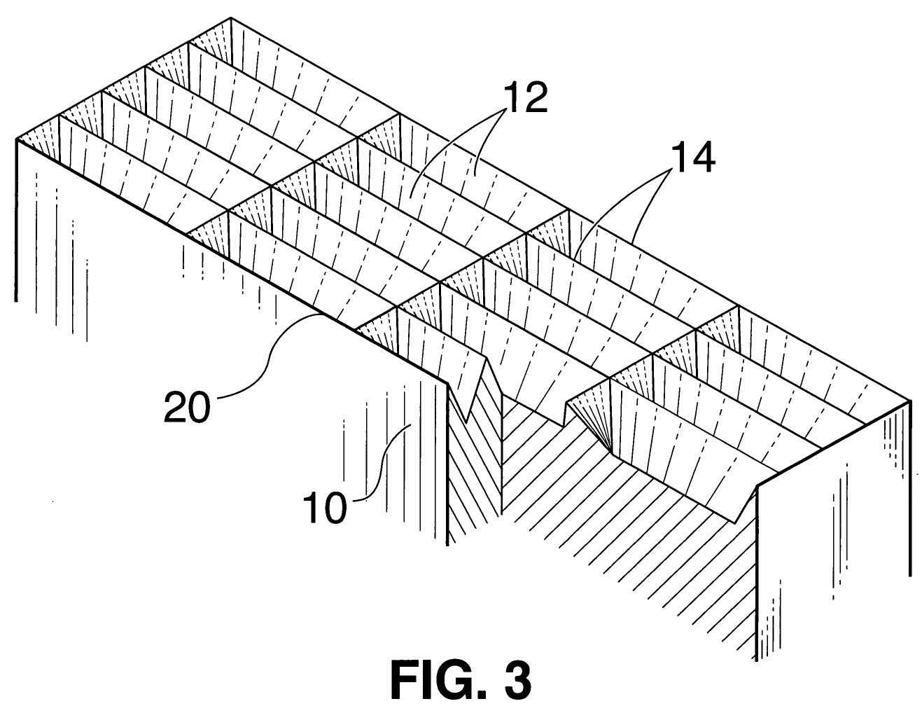

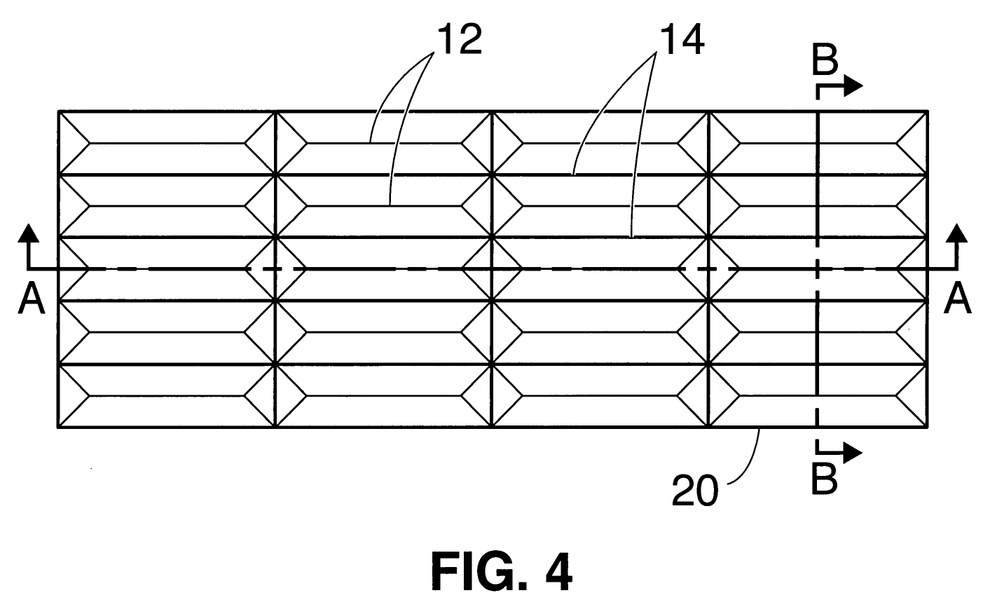

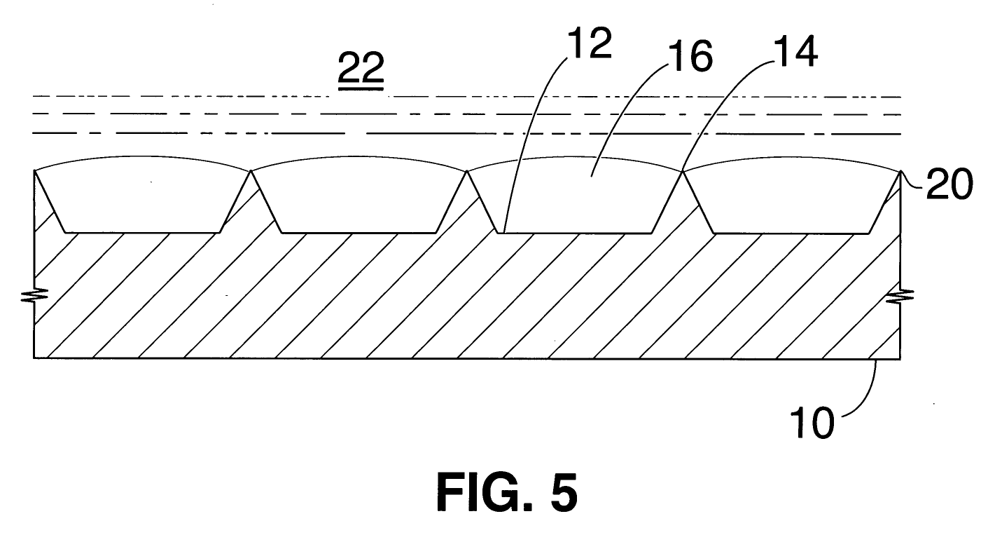

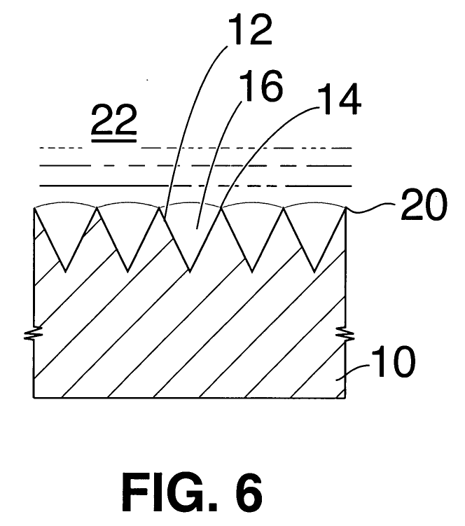

Referring to FIGS. 3-6, a base material 10 defines macroscale depressions 12, which may be in the form of an array that is open to the surface 20. The exact shape of the depressions 12 is not critical; they can be rectangular, pentagonal, hexagonal, rounded, elliptical, irregular, or any shape that is convenient. The depressions 12 are separated and enframed by ridges 14. It is preferable, but not critical, that the depressions 12 are elongated in the direction of the liquid flow, as evidenced by the longer lengths given in Table 1. Gas bubbles 16 are shown trapped in the depressions 12. The gas bubbles 16 provide minimal contact of the surface 20 with liquid 22.

Ridges

The ridges 14 protrude from the surface 20 to separate and enframe (define) each of the discrete depressions 12. It is preferable that the ridges 14 are sharp as shown to minimize the contact between the surface 20 and the liquid 22. The ridges 14 can be flattened, rounded, or otherwise shaped (not illustrated).

In cases where the ridges 14 are wedge-shaped as shown, the ridge half angle Φ should preferably satisfy the relationship:
Φ<Θ−90°

In the above relationship, Θ is the contact angle between the hydrophobic material and the liquid. The ridges 14 may also comprise narrow protrusive features with vertical sidewalls (in which case Φ=0 degrees). For the purposes of describing the present invention, a ridge 14 is defined as including up to the top 50%, preferably up to the top 20%, more preferably up to the top 10%, most preferably up to the top 5%, of the distance from the surface 20 to the bottom of a depression 12. The top of a ridge is the surface 20.

### Passive Material Embodiments

In passive embodiments of the invention, such as that illustrated in FIGS. 3-6, for example, the ridges 14 inhibit the flow of gas between the depressions 12. This inhibits the movement of the gas 16 across the surface 20, which prevents a pressure gradient in the liquid 22 from forcing the gas 16 off of the surface 20. In order to inhibit the flow of gas 16 between depressions 12, the microscale surface features of the hydrophobic base material 10 may be absent or minimal on the tops of the ridges 14. This minimizes the thickness of the gas 16 layer on top of the ridge 14 which could otherwise allow transfer of gas 16 between depressions 12.

If gas is lost from the surface, it may be replenished by picking up gas from the surrounding liquid. Gas in the surrounding liquid may be naturally present or may be intentionally forced into the surrounding liquid.

### EXAMPLE I

In accordance with the present invention, sodium borosilicate glass comprising 68.5 molecular % SiO₂, 23.6 molecular % B₂O₃, and 7.9 molecular % Na₂O is heat treated at 700° C. for 1 hour, resulting in phase separation via spinodal decomposition. The glass is cooled, and the surface is machined with a diamond cutter to produce macroscale depressions and ridges. The surface of the material is subsequently etched with an aqueous solution of HF, etching back the recessive phase and revealing the protrusive phase to produce microscale surface features. The microscale features are mechanically removed from the ridge tops by lapping. The surface is then coated with a hydrophobic self-assembled monolayer by immersing the material in a solution of (tridecafluoro-1,1,2,2 tetrahydrooctyl) trichlorosilane in hexanes.

### EXAMPLE II

In accordance with the present invention, differentially etchable glasses are drawn into a bundled array. The bundle is cut and the surface is machined with a diamond cutter to produce macroscale depressions and ridges. The surface of the material is subsequently etched with an aqueous solution of HF, etching back the recessive phase and revealing the protrusive phase to produce microscale surface features. The microscale features are mechanically removed from the ridge tops by lapping. The surface is then coated with a hydrophobic self-assembled monolayer by immersing the material in a solution of (tridecafluoro-1,1,2,2 tetrahydrooctyl) trichlorosilane in hexanes.

### EXAMPLE III

In accordance with the present invention, the material described in Example II is used as a mold for casting a hydrophobic polymer. A photocurable perfluoropolyether (See J. Rolland et al, J. Am. Chem. Soc. 126, pp. 2322-2323, 2004) is poured over the material in Example II and cured by exposure to ultraviolet light. The polymer is peeled off and used as a mold for casting a curing a second (possibly the same composition) hydrophobic polymer. The second casting, curing, and peeling step creates a duplicate of the original glass structure in a hydrophobic polymer, creating a drag reducing polymer structure.

### Active Material Embodiments

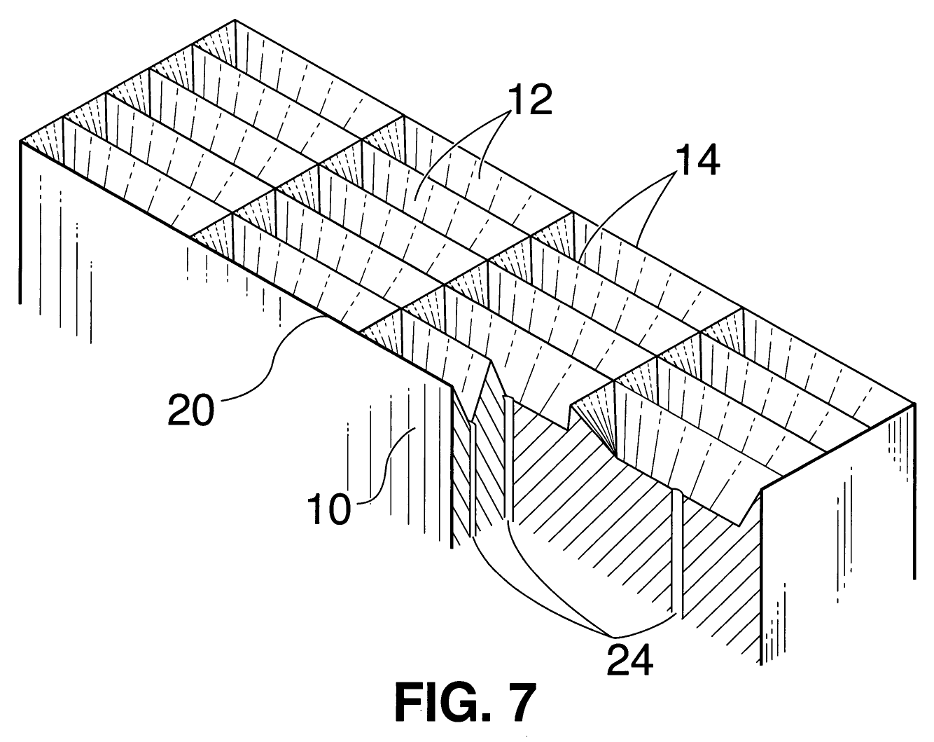

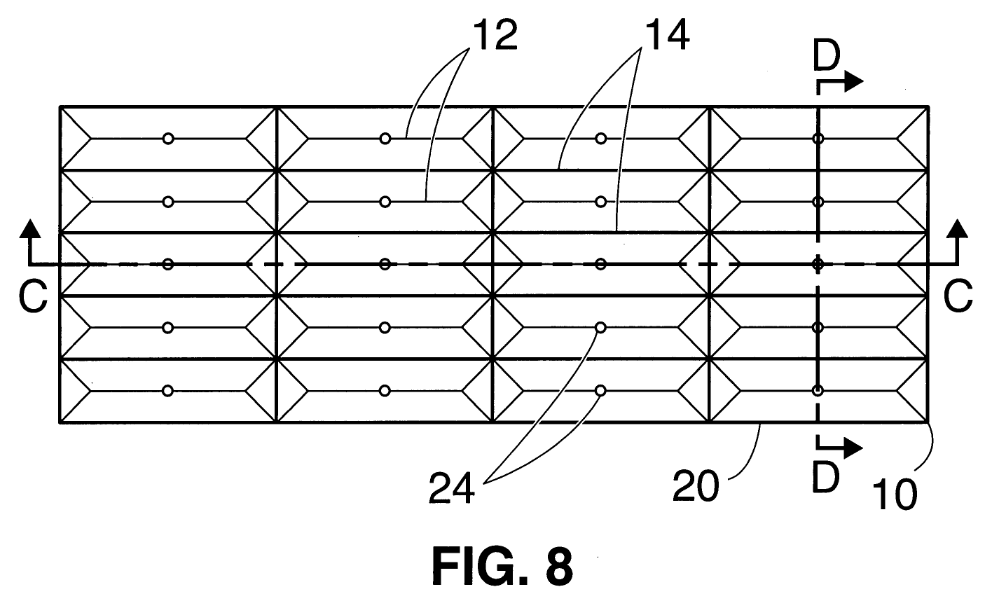

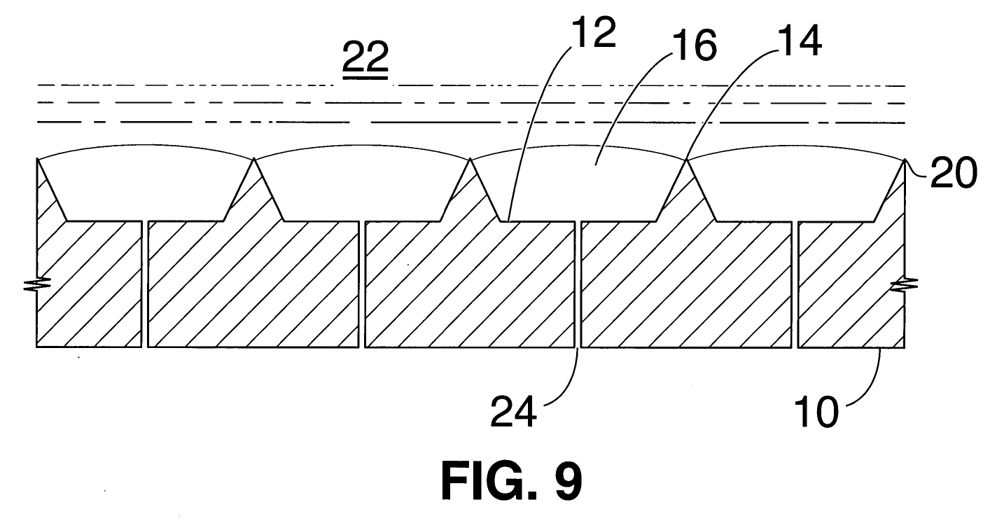

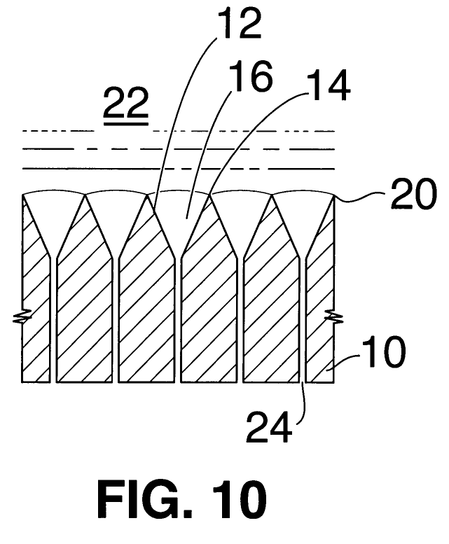

In active embodiments of the invention, such as that illustrated in FIGS. 7-10, for example, the gas 16 is replenished by forcing gas 16 through holes 24 which penetrate into the depressions 12 through the base material 10. The gas 16 on the surface 20 can thus be actively maintained and pressurized. Since gas 16 may be constantly added to the surface 20, it may not be as important to prevent the movement of gas among depressions 12 across the surface 20 as in passive material embodiments of the invention described above.

The invention is applicable to all types of sundry military, industrial, sport, and consumer watercraft applications such as, for example, cargo and passenger ships, boats, military ships, submarines and weapons, sailboats, motorboats, rowboats, personal watercraft, canoes, kayaks, surf boards, and the like. The invention is also applicable to non-watercraft applications such as, for example, ducts, pipes, swim suits, swim fins, microfluidic devices, and the like.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. An article comprising a body having at least one viscous drag-reducing surface defining a multiplicity of macro-scale depressions separated and enframed by ridges, at least a portion of said surface being phobic to a preselected liquid so that gas bubbles may be trapped in said macro-scale depressions in order to reduce viscous drag between said article and the liquid.

2. An article material in accordance with claim 1 wherein said surface material is further characterized by a micro-scale surface feature to enhance the phobicity of said surface material.

3. An article material in accordance with claim 2 wherein at least portions of said ridges are further characterized by reduced phobicity to said preselected liquid material relative to said macro-scale depressions.

4. An article material in accordance with claim 3 wherein at least portions of said ridges are further characterized by the absence of a micro-scale surface feature.

5. An article in accordance with claim 1 wherein said ridges are further characterized by a wedge-shape having a half angle Φ that satisfies the relationship Φ<Θ−90° where Θ is a contact angle between said viscous drag-reducing surface and the liquid.

6. An article in accordance with claim 1 wherein said surface material further defines holes which operably connect through said body to said depressions so that gas may be injected into said depressions via said holes.

7. An article in accordance with claim 1 wherein said surface is hydrophobic.
